(19) United States
(12) Patent Application Publication
(10) Pub. No.: US 2026/0084734 A1
(43) Pub. Date: Mar. 26, 2026

(54) ACCESSORY FOR USE WITH A DOLLY

(71) Applicant: Ronald Laumeyer, New Richmond, WI (US)

(72) Inventor: Ronald Laumeyer, New Richmond, WI (US)

(21) Appl. No.: 19/335,923

(22) Filed: Sep. 22, 2025

Related U.S. Application Data
(60) Provisional application No. 63/699,536, filed on Sep. 26, 2024.

(51) Int. Cl. B62B 1/14

(52) U.S. Cl. CPC B62B 1/14

(57) ABSTRACT

An accessory for use with a dolly includes a fixation structure configured to attach to and detach from a platform of the dolly, and an upright structure coupled to the fixation structure and extending upward from the fixation structure.

### CROSS-REFERENCE TO RELATED APPLICATIONS

This application claims the benefit of U.S. Provisional Application Ser. No. 63/699,536, entitled “Accessory for Use With a Dolly” and filed on Sep. 26, 2024, which is expressly incorporated by reference herein in its entirety.

### TECHNICAL FIELD

The present disclosure relates generally to structures for transporting items with a dolly, and more particularly to an accessory for use with a dolly that enables vertical stacking of items in a secure manner.

### BACKGROUND

When using a dolly, the item or items resting on the platform of the dolly can fall from the dolly during transport. This is especially true when items are vertically stacked on the platform. Straps can be used to secure the items in place. Straps, however, are inconvenient and can be unstable depending on the items being transported.

### SUMMARY

In one aspect of the disclosure, an accessory for use with a dolly includes a fixation structure configured to attach to and detach from a platform of the dolly, and an upright structure coupled to the fixation structure and extending upward from the fixation structure. The fixation structure creates a space between the upright arms of the dolly and the upright structure of the accessory that enables the vertical stacking of items in a secure manner.

### BRIEF DESCRIPTION OF THE DRAWINGS

Various aspects of apparatuses and methods will now be presented in the detailed description by way of example, and not by way of limitation, with reference to the accompanying drawings, wherein:

FIG. 1 is an illustration of an accessory having a fixation structure comprised of wedges that attach to a standard dolly for purposes of preventing items from falling from the dolly during transport.

FIG. 2A is a side view illustration of a fixation structure of the accessory.

FIG. 2B is a front view illustration of the fixation structure.

FIG. 3 is an illustration of the accessory adjacent to and detached from a dolly.

FIG. 4 is an illustration of the accessory attached to the platform of a dolly.

FIG. 5A is a front view illustration of items (e.g., pieces of wood) stacked between the accessory and the dolly arms.

FIG. 5B is a side view illustration of items (e.g., pieces of wood) stacked between the accessory and the dolly arms.

FIG. 6A is a partial illustration of an accessory having a fixation structure comprised of suction cups.

FIG. 6B is a partial illustration of an accessory having a fixation structure comprised of clamps.

### DETAILED DESCRIPTION

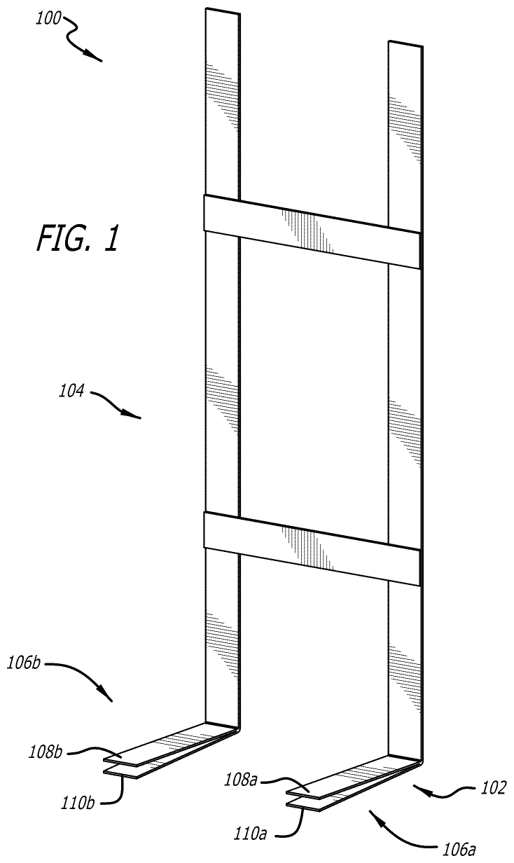

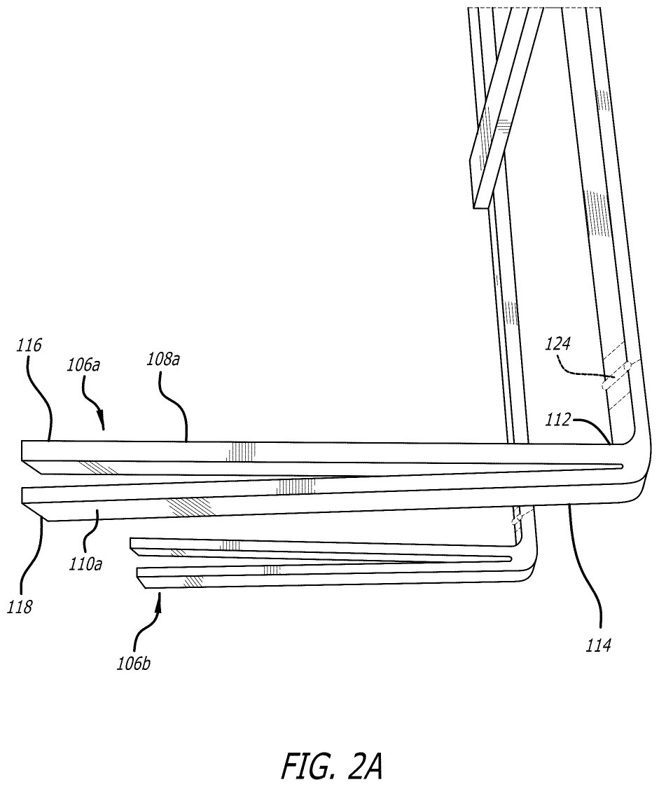

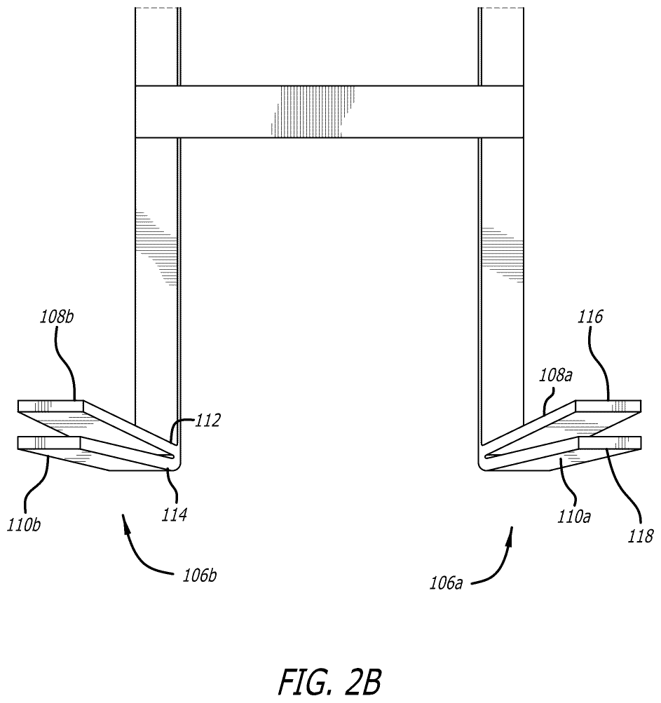

With reference to FIGS. 1-2B, an accessory 100 for use with a dolly 10 includes a fixation structure 102 and an upright structure 104. The fixation structure 102 is configured to attach to, and subsequently detach from, a platform 12 of the dolly 10. The upright structure 104 is coupled to the fixation structure 102 and extends upward from the fixation structure. The fixation structure 102 can be made of a metal, a heavy-duty, hard plastic, or any other similar material.

In some embodiments, the coupling between the upright structure 104 and the fixation structure 102 is by one or more hinges 124. Thus, the profile of the accessory 100 can be made narrow by pivoting the fixation structure 102 toward the upright structure 104 through the hinge 124. In other words, the accessory can transition between a collapsed state wherein the fixation structure 102 is close to parallel with the upright structure 104, and an expanded state wherein the fixation structure 102 is close to perpendicular with the upright structure 104.

With continued reference to FIGS. 1-2B, in some embodiments the fixation structure 102 includes a pair of wedge structure 106a, 106b, each having a top prong 108a, 108b and a bottom prong 110a, 110b that meet at respective first ends 112, 114 and taper away from each other in the direction of respective second ends 116, 118. In some embodiments, the fixation structure includes a single wedge structure.

In some embodiments, the space between the respective second ends 116, 118 of the top prong 108a, 108b and the bottom prong 110a, 110b of the fixation structure 102 is greater than the thickness of the platform 12 of the dolly.

In some embodiments, the space between the respective first ends 112, 114 of the top prong 108a, 108b and the bottom prong 110a, 110b is less than the thickness of the platform of the dolly. In this configuration, a friction fit is created between the fixation structure 102 and the platform 12 of the dolly 10.

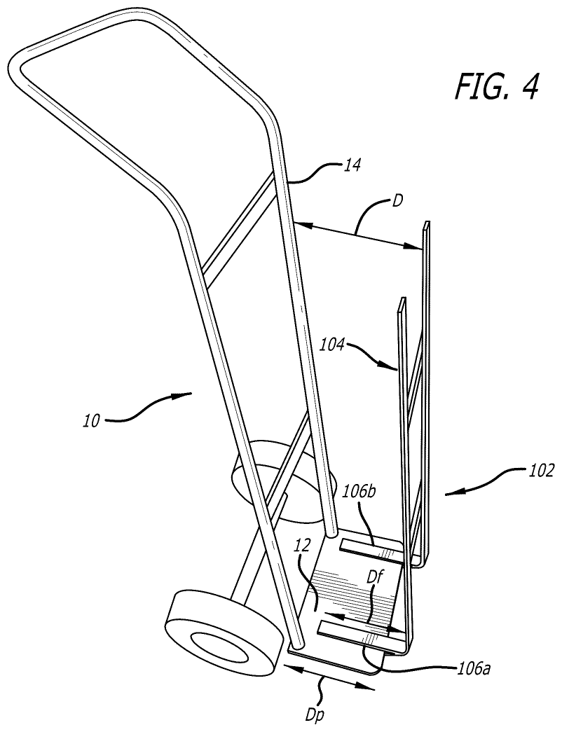

With reference to FIG. 4, the fixation structure 102 has a depth Df sized relative to the depth Dp of the platform 12 of the dolly 10 so that when the fixation structure 102 is attached to the dolly, the upright structure 104 of the accessory 100 is spaced apart from the upright structure 14 of the dolly 10. The distance D between the upright structure 104 of the accessory and the upright structure 14 of the dolly 10 can be between 0.5 to 2 feet.

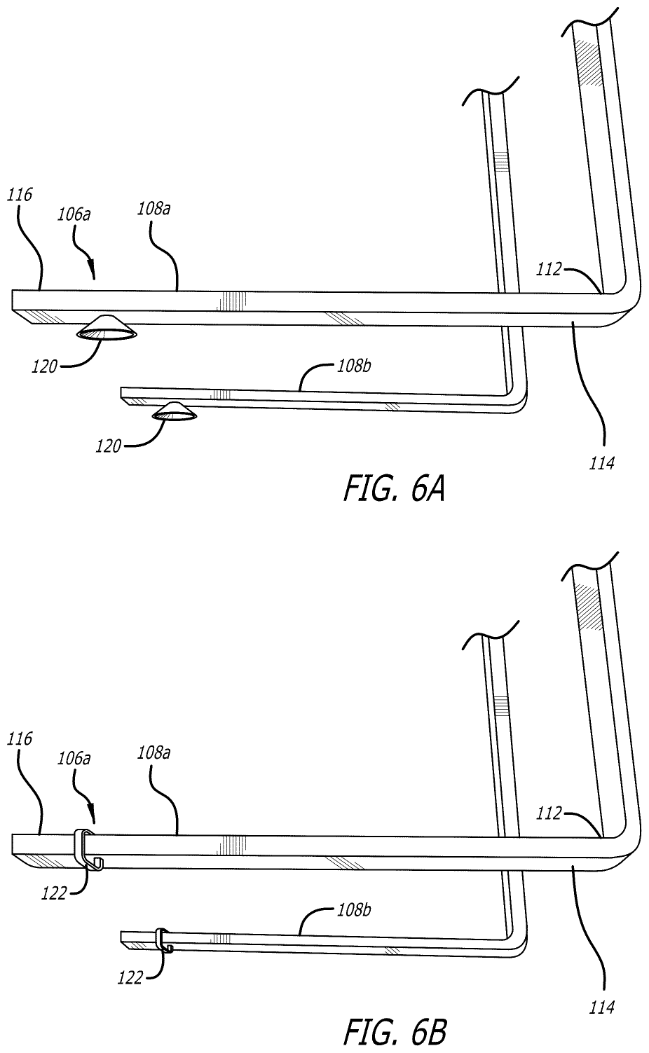

With reference to FIG. 6A, in some embodiments the fixation structure 102 includes two prongs 108a, 108b, each having a suction structure 120 (e.g., suction cup) that extends from the bottom of a prong. The suction structure 120 is configured to attach to and detach from a surface of the platform 12 of a dolly 10.

With reference to FIG. 6B, in some embodiments the fixation structure 102 includes two prongs 108a, 108b, each having a clamp structure 122 that is associated with a prong. The clamp structure 122 is configured to be clamped to and released from the platform 12 of the dolly 10.

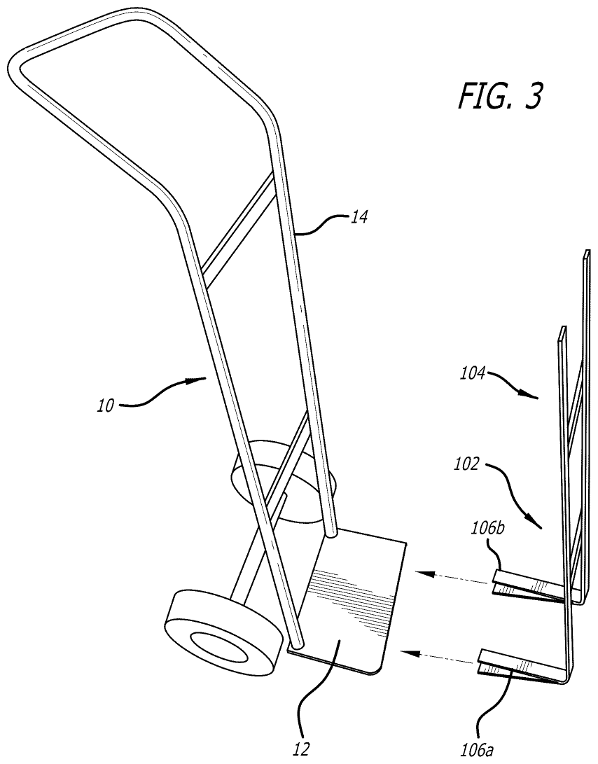

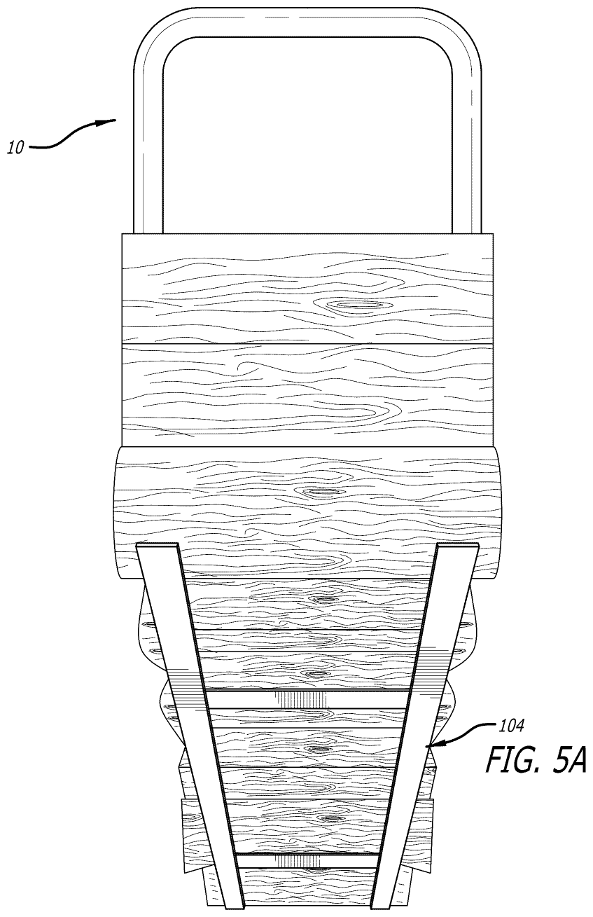

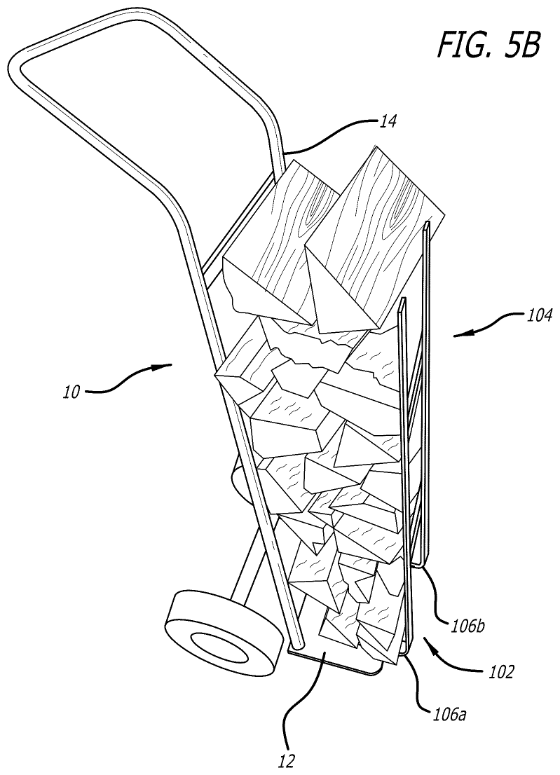

With reference to FIGS. 3-5B, in an example application, the accessory 100 is used in combination with a dolly to transport pieces of split wood. The wood mover, i.e., the accessory 100, can be slid onto a two-wheel home dolly 10. In this embodiment, the fixation structure 102 includes a pair of wedge structures 106a, 106b that secure the accessory 100 to the platform 12 of the dolly 10 through a friction fit. Split wood is then vertically stacked in the space between the upright structure 14 of the dolly 10 and the upright structure 104 of the wood mover 100. The vertical stack of split wood can then be securely moved to a location near a fireplace or fire pit. The dolly 10 can then be separated from the wood mover 100 and the split wood can be stored in place on the wood mover. The wood mover 100 can also be used as a log rack in the home, cabin, or campsite. Alternatively, the split wood can be unloaded from the dolly/wood mover.

The various aspects of this disclosure are provided to enable one of ordinary skill in the art to practice the present invention. Thus, the claims are not intended to be limited to the various aspects of this disclosure, but are to be accorded the full scope consistent with the language of the claims.

What is claimed is:

1. An accessory for use with a dolly, the accessory comprising:
a fixation structure configured to attach to and detach from a platform of the dolly; and
an upright structure coupled to the fixation structure and extending upward from the fixation structure.

2. The accessory of claim 1, wherein the fixation structure comprises at least one wedge structure comprising a top prong and a bottom prong that meet at respective first ends and taper away from each other in the direction of respective second ends.

3. The accessory of claim 2, wherein the space between the respective second ends of the top prong and the bottom prong is greater than the thickness of the platform of the dolly.

4. The accessory of claim 2, wherein the space between the respective first ends of the top prong and the bottom prong is less than the thickness of the platform of the dolly.

5. The accessory of claim 2, wherein the fixation structure comprises at least two wedges.

6. The accessory of claim 1, wherein the fixation structure comprises at least one prong and a suction structure associated with the at least one prong and configured to attach to and detach from a surface of the platform.

7. The accessory of claim 1, wherein the fixation structure comprises at least one prong and a clamp structure associated with the at least one prong and configured to clamp to the platform of the dolly.

8. The accessory of claim 1, wherein the fixation structure has a depth sized relative to the depth of the platform of the dolly so that when the fixation structure is attached to the dolly, the upright structure of the accessory is spaced apart from the upright structure of the dolly.

9. The accessory of claim 1, further comprising a hinge configured to couple the fixation structure to the upright structure to enable the accessory to transition between a collapsed state and an expanded state.
